(19) United States
(12) Patent Application Publication
(10) Pub. No.: US 2007/0244757 A1
(43) Pub. Date: Oct. 18, 2007

(54) Automated system and method for advertising, utilizing an online sweepstakes

(76) Inventor: Brett Walter, Portola Valley, CA (US)

Correspondence Address: DLA PIPER US LLP, 2000 UNIVERSITY AVENUE, E. PALO ALTO, CA, 94303-2248, US

(21) Appl. No.: 11/728,649

(22) Filed: Mar. 26, 2007

Related U.S. Application Data
(60) Provisional application No. 60/786,162, filed on Mar. 27, 2006.

(51) Int. Cl. G06Q 30/00; A63F 9/24

(52) U.S. Cl. 705/14; 463/16

(57) ABSTRACT

A unique web-based advertising model permits an automated method for advertising a merchant's goods or services on-line by offering electronic prize tickets to interested participants over one or more websites in exchange for either visits by participants to the merchant's website or referrals by participants to other prospective participants via electronic communication.

### PRIORITY CLAIM/RELATED APPLICATION

This application claims priority under 35 U.S.C. §119(e) to U.S. Provisional Patent Application Ser. No. 60/786,162 filed on Mar. 27, 2006, and entitled “A System and Method for Advertising, Utilizing an Online Sweepstakes” which is incorporated herein by reference.

### FIELD OF THE INVENTION

The invention relates generally to a method for advertising, and in particular to a system and method for improving advertising techniques in a network environment using, for example, an online, interactive sweepstakes.

### BACKGROUND OF THE INVENTION

The advent of the World Wide Web has had a revolutionary impact as a communications and advertising medium. Whereas prior media, such as newspaper, radio and television, generally utilized regional content that was distributed on a periodic and costly basis, because of its ubiquitous nature, the Internet presents a relatively free and global medium that is available to everyone, anywhere, at any time. As a result, more and more businesses have turned to the Internet as a major marketing tool and have established websites to help market their products and services to potential users, just as they had developed advertising and marketing content for the more conventional forms of media. However, unlike the relatively static and limited advertising that companies traditionally used for radio, television and newspapers, because of the Internet's dynamic, real-time nature, and its viability as a significant sales channel, it became important to develop unique advertising techniques that could draw as many users to a particular website as possible.

Many different on-line advertising techniques have been utilized to accomplish this goal over the last several years. Certain of these techniques are described in the following paragraphs. However, as noted, each of these techniques, while beneficial, has ultimately proven limited in the ability to draw the maximum possible number of interested Internet users to particular websites of interest, and have thus frequently been unsuccessful in achieving the increased sales volume businesses hoped for when turning to the Internet as a sales channel and marketing tool.

Awards and competitions, for example, have been used in the past as an Internet marketing tool in an attempt to drive more individuals to a particular website. Indeed, the prestige associated with unique awards can lend instant credibility to the products and offerings of the website merchant or supplier. Such awards are designed to convince that being identified as a member of a particular award club is a limited exclusive benefit and adds instant credibility to the sales efforts of the merchant or organization. However, prestige awards generally only indirectly benefit the merchant or organization, not the end-user who may visit the site, and attract only a limited subset of Internet users who are particularly interested in the discrete subject matter being offered by the award member.

Another type of conventional online advertising technique is the use of an E-zine or newsletter which generally focuses on discrete subject areas. As such, they are limited in their effectiveness as an advertising and marketing tool since they tend to attract only a subset of Internet users that are devoted to that particular subject matter, rather than attract a wide set of previously unaware Internet users. Moreover, the amount of work required to maintain a successful E-zine is typically expensive and because an average E-zine or newsletter can adversely impact ones marketing efforts due to such costs, this tool has generally not been widely accepted.

Premiums are a third example of conventional online advertising techniques. In the real world, premiums can include things such as coffee mugs, ties, and key chains. Typically, a high quality logo and/or company name is printed on the item and it is given away for free in an effort to entice the recipient to revisit the source of the premium so that the merchant can close future sales with that recipient and build brand loyalty with the customer. While premiums are traditionally recognized as a brick-and-mortar marketing tool, an online business can also utilize these premiums in Internet marketing, typically in the form of items such as screen savers, backgrounds, mouse pointers, and mouse pads. Premiums, however, are limited in their ability to entice recipients to revisit their source, as most individuals often forget about the company offering the premium after several days. Moreover, they do not lend themselves well to interactivity between merchant and potential customer and thus are limited in their ability as a sales and marketing tool.

Speeches and articles have also been used as forms of on-line advertising. The benefit of marketing through speeches and articles is that they automatically identify oneself or one's organization as a leading authority or provider in a particular field. Unfortunately, though, speeches do not lend themselves well to an on-line environment such as the Internet, and while articles are more easy to promulgate in the Internet medium, they tend to be focused on discrete subject areas and are more informational and thus are typically identified only by Internet researchers, instead of serving as an effective tool for drawing new Internet customers to one's website to close sales leads.

Bonuses are another proven advertising technique. An example of a bonus could be “Buy this cook book for just $10 and get a free 4-day e-mail course on creative cooking.”Because they are designed to assist product sales, bonuses have become a common and widely adopted on-line marketing technique. However, because of their nature, bonuses are typically short-lived promotions, and because they typically involve a free offering, are frequently deemed unsatisfactory owing to inherent delay, their cost, and the cost of getting the bonus to the recipient.

Still another conventional marketing technique used on the Internet is free samples. Free samples attract attention; if the sample is good, the attention it draws can turn into new sales. Free samples can also help build trust in the provider. However, free samples are often unsatisfactory in an Internet setting, in part due to the inherent delay and cost of getting the free sample to the recipient. Moreover, it is often difficult and expensive for businesses to distribute information about their free samples to a widespread audience and thus the ability of the free samples by itself to draw new, unfamiliar users to one's website is somewhat limited. Additionally, the free sample is generally designed to entice only the prospective purchaser of the promoted item and not a wider audience, and can be limiting in its ability to attract previously unfamiliar users to a particular website.

Special offers can also be used as a marketing tool. Special offers are generally used to make one's customers and subscribers feel special, thereby increasing their customer loyalty which in turn can lead to increased sales to these customers and subscribers. Examples of special offers can include offering particular customers special products or services, informing them of new products or services before informing anyone else, and sending them particular products for free that other people have to pay for. Another example could involve the use of “thank you” notes. Typically, companies use such communications with their customers to make the experience more personal for them, which increases the likelihood that the particular customer will form an emotional bond with the offering party which can lead to additional future business because of the increased customer loyalty. However, because special offers are generally designed to build on the loyalty of the known customer base, they are typically not useful as a tool to attract new, unfamiliar website users.

The offering of free services, on the other hand, is a conventional advertising technique that can be used as a way to attract attention to one's product from those who are not already familiar about the particular company, by offering something for free on the side. Free promotions draw potential new customers or subscribers to one's online site, and once there, the ability to sell products or offer services to these new individuals can be realized. However, it is often difficult and expensive for businesses to distribute information about their free promotions to a widespread audience and thus, the ability of the promotion by itself to draw new, unfamiliar users to one's website is somewhat limited.

Context-sensitive, cost-per-click advertising systems, such as those exemplified by Google™ AdWords™ and Google AdSense™ have proven to be a successful advertising vehicle for many advertisers. However, this form of advertising is increasingly expensive, and thus many merchants who may have used such systems previously are likely unable to continue doing so. Moreover, merchants generally incur costs from each click, whether or not the click to their site results in a sale, which is generally undesirable.

As noted above, there are deficiencies with these previously recognized techniques that limit their effectiveness as Internet marketing tools. There remains a need for a unique and potentially lower cost advertising model over the World Wide Web that achieves a significant increase in the effectiveness in drawing as many interested users to a particular website as possible. One such technique is described in the accompanying specification and illustrated with reference to the following figures.

### SUMMARY OF THE INVENTION

A unique web-based advertising model is presented which permits an automated method for advertising a merchant's goods or services on-line by offering electronic sweepstakes tickets to interested participants over one or more websites in exchange for either visits by participants to the merchant's website or referrals by participants to other prospective participants via electronic communication. As such, the system can be used as a customer acquisition and retention tool with built-in lead generation and lead conversion capabilities. Such invention may be employed equally well in embodiments other than sweepstakes, such as raffles, door prizes and other activities that involve the trading of tickets—whether purchased, free, or earned in exchange for desired behavior—for prizes.

One embodiment of the invention can be implemented by software executing on one or more computer servers over a cellular or computer network, such as the Internet, whereby merchants can enter prizes into an on-line sweepstakes and define advertising rules for the sweepstakes all via a remote system such as a personal computer, cellular phone, or other wired or wireless device connected to the network. The software can be configured to publish the prizes to one or more sweepstakes with HTML links to one or more merchants' websites for concurrent viewing by multiple participants, each of whom may participate at their leisure via a remote system such as a personal computer, cellular phone, or other wired or wireless device connected to the Internet. Advantageously, the server software may interact remotely with a central database to store records of merchant prizes, merchant rules, and participant interaction in the sweepstakes.

A preferred aspect of the invention is that the sweepstakes can be self-administering. That is, merchants can contribute prizes to the sweepstakes and monitor activity on a self-service basis and participants can “play” for prizes without intervention by the sponsor. Moreover, sponsors can preferably deploy sweepstakes to their websites on a self-service basis. By interacting with any properly configured website server on the network, merchants may publish prizes to sweepstakes concurrently operating on any other properly configured and affiliated website on the network. Thus, any affiliated websites may display sweepstakes prizes from any contributing merchant.

The sweepstakes may be perpetual, in that while any individual prize in the pool of sweepstakes prizes may have its own unique odds and its own unique “win” date or other mechanism for termination, the sweepstakes remains ongoing so long as there is at least one prize in the sweepstakes.

Preferably, the sweepstakes is automated so that after an initial manual setup by the appropriate parties, the operation and maintenance of the system is entirely automated and does not require manual administration. During the setup of the sweepstakes, merchants may specify rules concerning, for example, the number of electronic sweepstakes tickets (“e-Tickets”) or prize tickets that should be issued before their prize in the sweepstakes is won. Merchants may also specify rules concerning the number of e-Tickets that should be issued for each visit to the merchant's website or referral of another to the merchant's website. Moreover, merchants can increase these numbers to increase the incentive for each participant to visit or refer people to the merchant's website.

Merchants may also configure prizes to be perpetual, such that when a prize is won the system can automatically publish a duplicate prize into the prize pool for the sweepstakes. In this manner, the merchant can contrive to have a prize in the pool continuously, which can generate enhanced user traffic visits to the merchant's website without additional effort beyond the initial prize setup for the sweepstakes. Unlike traditional sweepstakes, however, merchants do not necessarily pay to contribute their prizes to a sweepstakes pool. Rather, they can use their own product or service offerings as a form of currency to generate sales leads. Merchants may also specify a consolation prize message which can be sent automatically via electronic communication to opted-in, non-winners of each prize.

The system may be accurately characterized as a “lead generation” system, in that one of the preferred aspects of the invention is to stimulate interest by participants in the participating merchant's products. As such, participants who collect tickets to win a particular prize may be considered “qualified leads” or “qualified prospects” by the prize's merchant. To that end, the consolation message aspect of the invention can serve as a mechanism whereby the merchant can attempt to convert qualified leads into paying customers. In this respect, the system may also be accurately characterized as a “sales conversion” system. Moreover, participants may receive one or more tickets for each visit or referral to a merchant website, and thus, merchants can ensure that the desired number of people visit or know about their website before they release the prize.

An observed benefit of the invention is that it permits merchants to attract qualified visitors (i.e., “qualified leads”) to their websites according to rules of their own choosing, and without having to pay cash directly for those visitors to visit their website, as is generally required by other on-line advertising methods, such as those employed by Google™ AdWords and other pay-per-click or pay-per-performance systems. Moreover, merchants can assign retail values to their offered prize items that are considerably higher than their actual cost for those items, thereby giving them a more cost-effective way to advertise than with other on-line forms of advertising. As such, merchants can pay for visits from qualified leads with product, which is generally considered to be better, and less expensive, than paying for such leads with cash.

Another preferred aspect of the invention is the ability by participants to acquire additional tickets for a prize by referring a merchant's website to one or more of their friends via electronic communication. This is a form of viral marketing that the system allows, and thus the invention can stimulate viral behavior among target markets by giving participants a motivation to tell their friends about a particular merchant or website without exposing their friends to unwanted solicitations by such merchants.

These and other preferred aspects and advantages of a preferred embodiment of the invention are described in more detail in the accompanying specification and illustrated in the following figures which are illustrative and are not intended to be limiting.

### BRIEF DESCRIPTION OF THE DRAWINGS

FIG. 1 illustrates a block diagrammatic architectural view of an embodiment of the invention;

FIG. 2 illustrates a block diagrammatic view of the various functional modules that may be provided in the sweepstakes management software;

FIG. 3A illustrates exemplary portions of a user interface that may be presented to a merchant using the Merchant Interface module in FIG. 2;

FIG. 3B illustrates another exemplary portion of the user interface in FIG. 3A that may be presented to a merchant using the Merchant Interface module in FIG. 2 to add a prize to a sweepstakes;

FIG. 3C illustrates still another exemplary portion of the user interface in FIG. 3A that may be presented to a merchant using the Merchant Interface module in FIG. 2 to add a prize to a sweepstakes;

FIG. 3D illustrates yet another exemplary portion of the user interface in FIG. 3A that may be presented to a merchant using the Merchant Interface module in FIG. 2 to add a prize to a sweepstakes;

FIG. 4 illustrates another exemplary portion of the user interface associated with FIG. 3A that may be presented to a merchant as a preview of a prize in advance of submitting it into a sweepstakes;

FIG. 5 illustrates an exemplary list of sweepstakes in which a particular merchant's prize has been submitted;

FIG. 6 depicts an exemplary statistics screen that specifies certain statistics related to a particular sweepstakes prize that can be tracked by the system;

FIG. 7 illustrates an exemplary list of affiliated websites that may be displayed upon selecting to publish a prize to all affiliated websites from the “Add A Prize” form in FIG. 3C of the Merchant Interface;

FIG. 8 is an exemplary screen shot of a Sweepstakes webpage that may be displayed on a participant's web browser as generated by the Participant Interface software module;

FIG. 9A shows an exemplary view of a confirmatory pop-up window that may be displayed to a participant after electing to acquire a prize ticket;

FIG. 9B shows an exemplary view of a pop-up window that may be displayed to a participant after having already exceeded the threshold number of prize tickets for a particular prize;

FIG. 10 shows a representative webpage for referring a friend to a merchant's website as provided by the Participant Interface module of the software;

FIG. 11A is an exemplary screen shot of a portion of a user interface that may be displayed to a sweepstakes manager via the Sweepstakes Manager Interface; and

FIG. 11B is an exemplary screen shot of another portion of a user interface that may be displayed to a sweepstakes manager via the Sweepstakes Manager Interface.

FIG. 12 is an exemplary screen shot of a consolation message that may be sent automatically to an opt-in non-winner of a sweepstakes prize.

### DETAILED DESCRIPTION OF A PREFERRED EMBODIMENT

A preferred embodiment of the invention will now be described in detail with reference to the accompanying drawings. FIG. 1 illustrates a block diagrammatic architectural view of an embodiment of the invention 100. As shown in FIG. 1, one or more users or participants (P₁-P_{N}) 110 may access one or more website servers (W₁-W_{N}) 120 via a computer network such as the Internet 130. Such users 110 may access the Internet 130 using, for example, a personal computer loaded with any form of Internet browser software, or may use other communications devices that are capable of establishing a connection to the World Wide Web, such as cellular phones, Personal Digital Assistants, or other wired or wireless devices. To access the one or more website servers 120, such users 110 direct their browser (or communications) software to access a particular website of their choosing, such as by entering the appropriate URL address into the browser's navigational toolbar or by clicking a link on a website page. The one or more websites are managed by one or more computer servers 120 which preferably implement a Javascript software program (J₁-J_{N}) 140 that permits one or more merchants (M₁-M_{N}) 150 to utilize on-line sweepstakes functionality on their websites. The Javascript software program 140 is utilized to display sweepstakes games on the merchant's 150 website.

Preferably, system software (SS₁-SS_{N}) 170 that executes the sweepstakes functionality, such as the creation and inclusion of prizes into various sweepstakes, the selection of sweepstakes winners, and the tracking of interactions associated with each sweepstakes, is resident on one or more server computers (S₁-S_{N}) 180 which are accessible by merchants 150 and/or sweepstakes managers via the communications network 130, such as by utilizing their personal computers (or other communications devices) loaded with any form of Internet browser software or other software that is capable of accessing the software 170. The servers 180 thus push relevant sweepstakes data to the webservers 120 whose websites have embedded therein the appropriate Javascript program 140 to display sweepstakes games.

While the preferred embodiment shown in FIG. 1 illustrates multiple software modules 170 each executing on an individual server 180, in an alternative embodiment (not shown), a single executable software program resident on a single server may manage multiple sweepstakes that are conducted on multiple websites. In yet another alternative embodiment (not shown), the executable software may reside on a single master server and be configured to push sweepstakes information out to multiple websites via, for example, RSS feed or some other communications method. Still another alternative embodiment (not shown) can include executable software residing on a single server and managing sweepstakes on one or more websites being served from the same server or from different servers that are configured to support single or multiple websites.

Returning to FIG. 1, the software 170 running on the one or more computer servers 180 may be configured to publish the prizes (with links to the offering merchant's website if desirable) to one or more websites for concurrent viewing by multiple participants 110 over the Internet or other network. As is discussed in more detail below, such participants 110 may participate in any of the available sweepstakes using, for example, their Internet web browser software on their personal computer to access an appropriate web server 120 which provides access to a website having sweepstakes functionality.

The server software 170 preferably interacts with a central database (D₁-D_{N}) 160 associated with the server 180 to store information associated with the sweepstakes, such as records of merchant prizes, merchant rules and participant interaction. It should be noted, however, that the use of a centralized database is merely preferable and other embodiments can be utilized where a centralized database is not used at all, such as where each sweepstakes implementation can store any needed information on its own local memory in the server and exchange any needed information with other sweepstakes implementations via a messaging protocol.

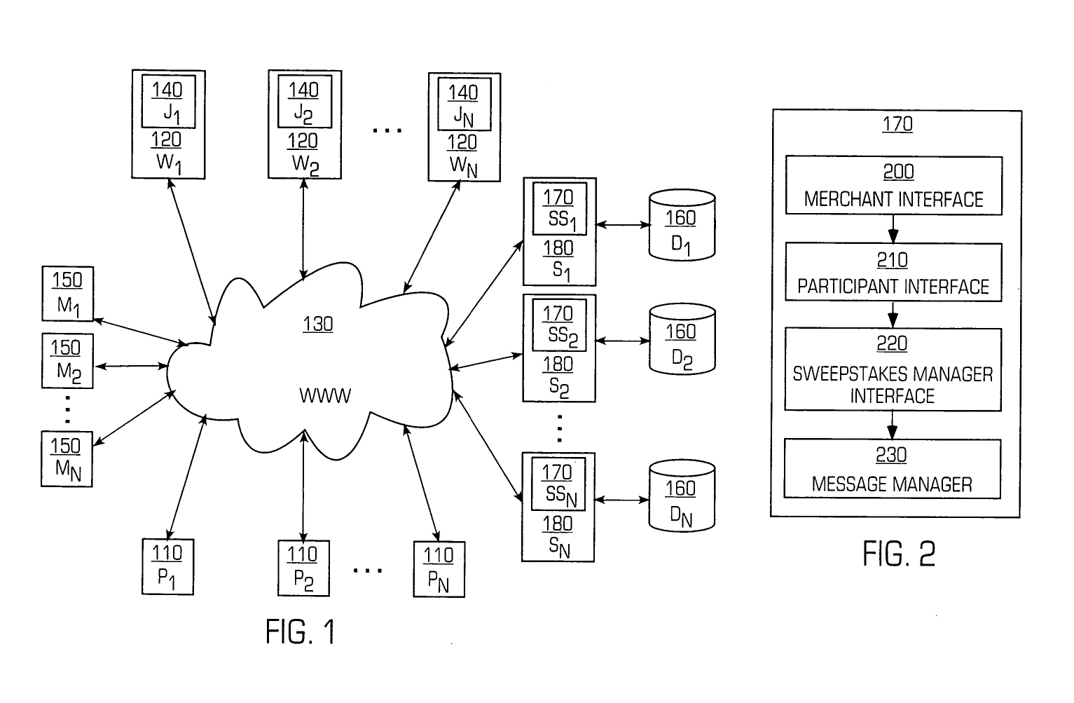

As noted, the sweepstakes functionality is preferably managed by executable software 170 residing on one or more servers 180 that are accessible via the Internet 130. The software 170 may preferably be configured to perform one or more of the following functions: capture prize and rule submissions by merchants; display sweepstakes prizes on properly configured websites; track and display changes to the status of a sweepstakes; select winners at appropriate times; and notify winners, non-winners, and merchants as needed. These functions are described in more detail below with reference to various functional modules of the software 170, which are shown in more detail in FIG. 2.

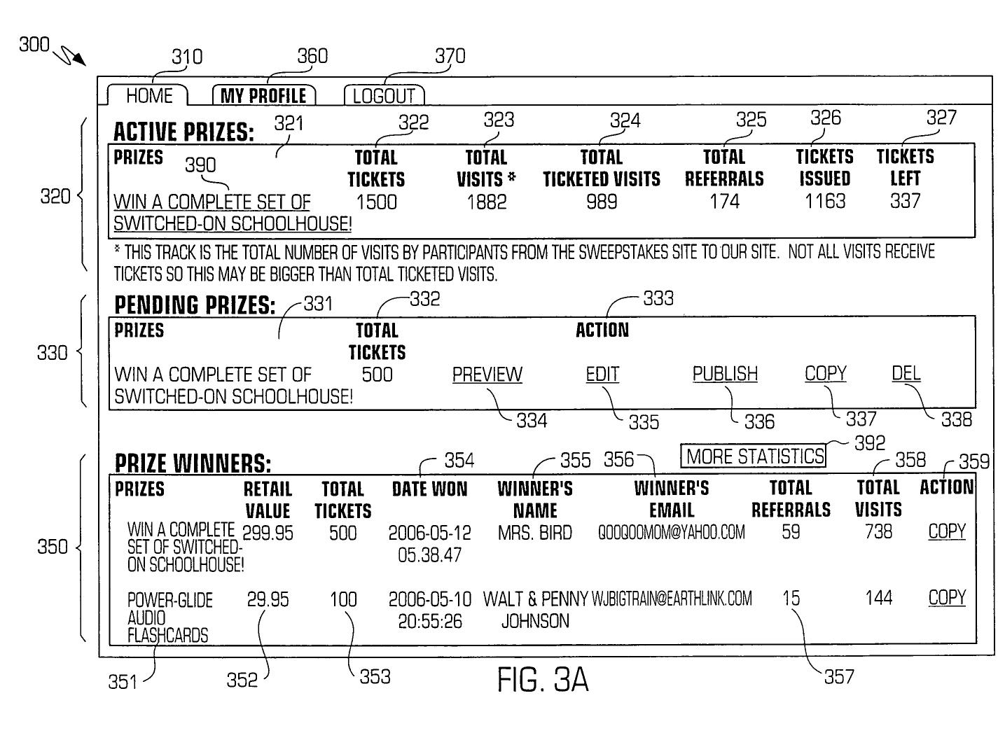

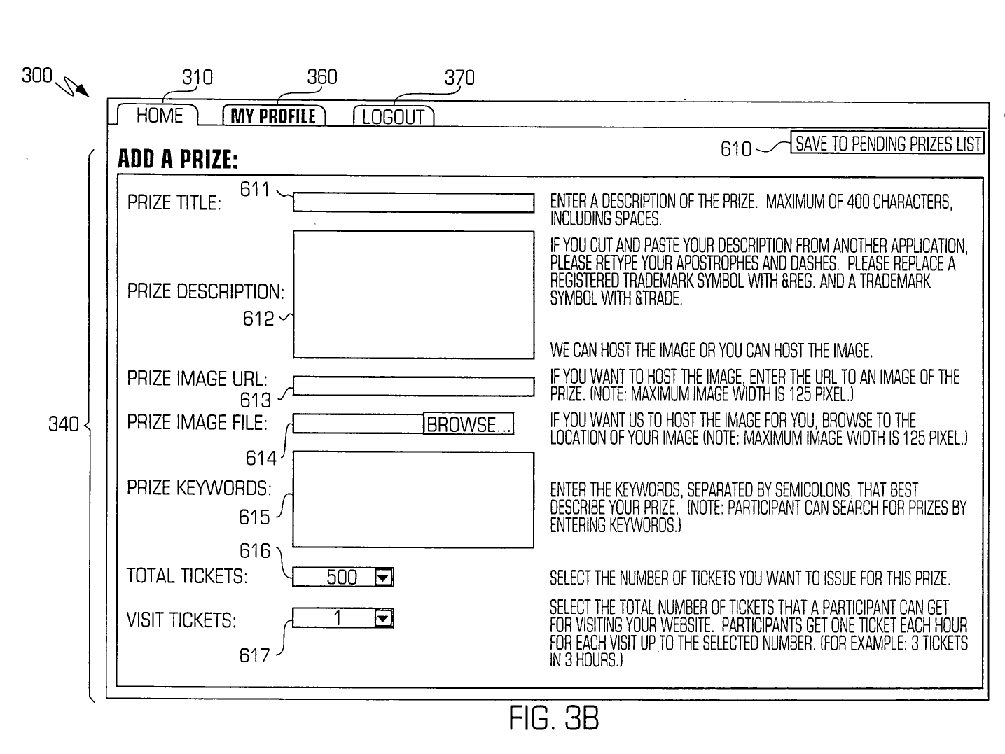

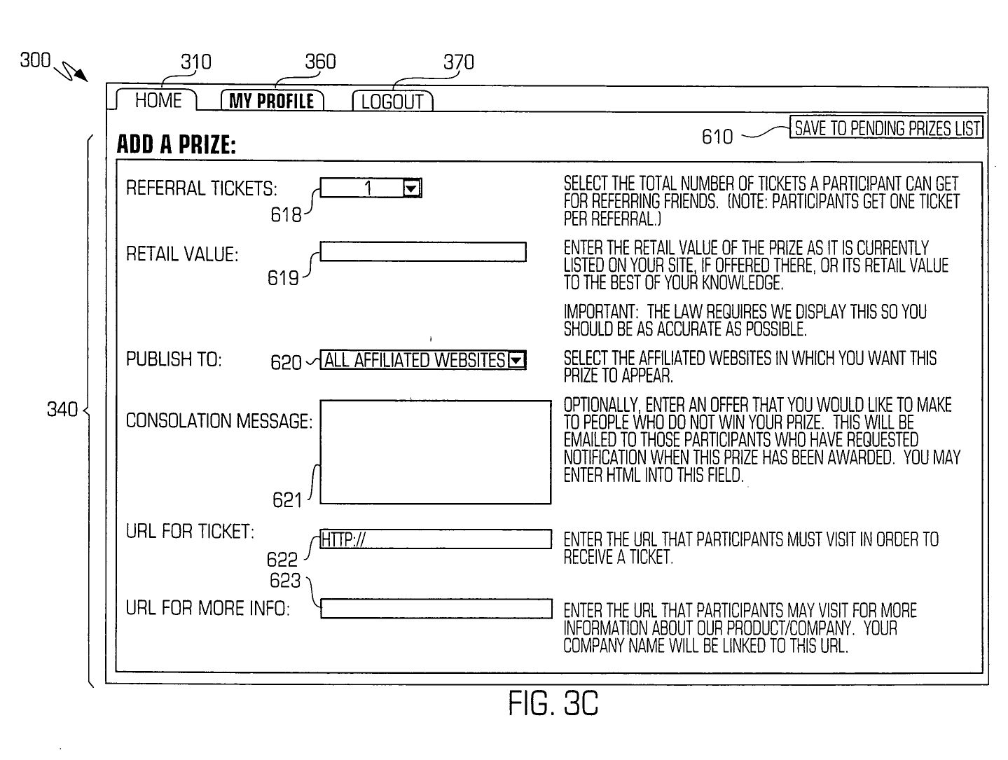

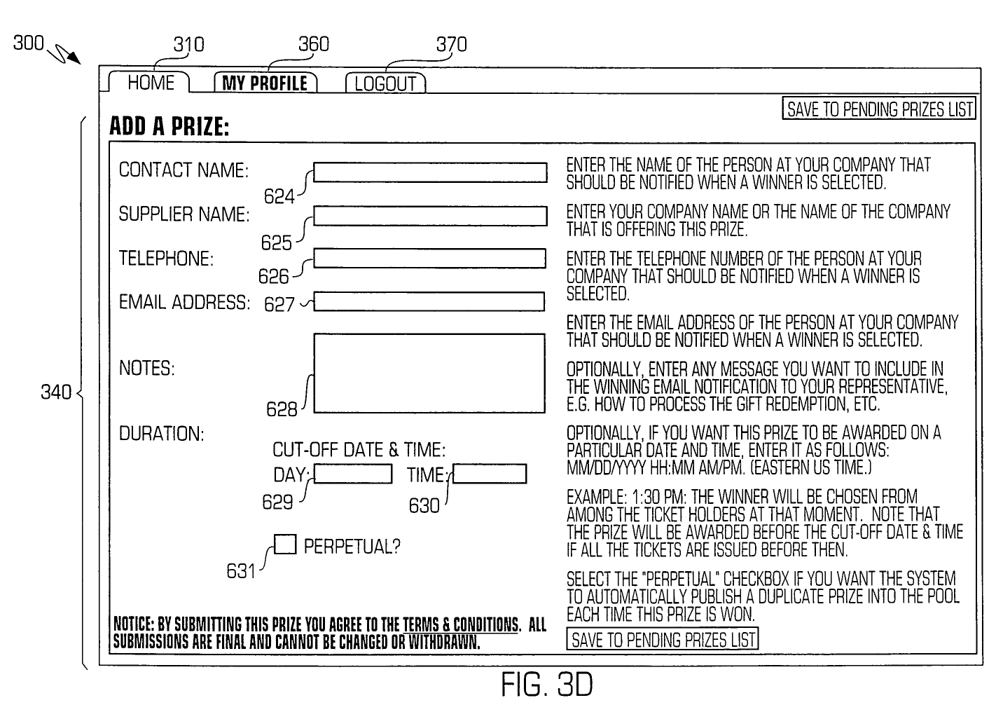

One functional module that may preferably be provided for by the software 170 is a Merchant Interface module 200. Using his or her personal computer or other communications device, a merchant 150 may access the server 180 and interact with the Merchant Interface module 200 of the software 170 to, among other things, submit prizes to one or more sweepstakes in order to attract visitors, and hence prospective customers, to his or her website. For example, a merchant may access the software 170 on the server 180 and log in to his or her individual account thus gaining access to the Merchant Interface module 200. Once logged into the Merchant Interface module 200, the merchant 150 may be presented with a user interface that permits him or her to navigate to various functional pages within the Merchant Interface 200 and interact with the software 170 accordingly. Select portions of an exemplary user interface 300 for the Merchant Interface module 200 are shown in FIG. 3A, highlighting certain functionality that may be available to the merchant upon selecting the Home tab 310 or designated link in the user interface 300. FIGS. 3B, 3C and 3D show other portions of the exemplary user interface in FIG. 3A, illustrating additional functionality that may be available to the merchant upon selecting the Home tab 310 or designated link in the user interface 300. Preferably, the user interface 300 is such that the portions shown in FIGS. 3A, 3B, 3C and 3D are collectively contained on a single presentation page of the user interface 300. Furthermore, FIGS. 3B, 3C and 3D collectively illustrate an exemplary user interface 300 for the functionality enabling a merchant 150 to add a prize to a sweepstakes.

As shown in FIGS. 3A, 3B, 3C and 3D, the user interface 300 of the Merchant Interface module 200 may be designed so as to provide the merchant 150 with multiple options, such as reviewing a list of active prizes 320 that the merchant 150 has already submitted to a sweepstakes, reviewing a list of pending prizes 330 that the merchant 150 is preparing to submit to a sweepstakes, viewing a proof of a prize to be added to a sweepstakes, adding a prize 340 to the list of pending prizes 330, and reviewing a list of prior prize winners 350 of the merchant's sweepstakes prizes.

Preferably, the Merchant Interface module is programmed using PHP, JAVA, C+, C++, PERL, JAVASCRIPT or other programming language which allows for a streamlined user interface presentation 300 in a merchant's 150 browser. It should be noted that the particular user interface presentation 300 illustrated in FIGS. 3A-3D is exemplary only, as any type of information (and the location of the information) can be chosen by the software designer for display in the user interface 300 to the merchant 150.

As shown in FIG. 3A, the Merchant Interface 200 may be represented on a merchant's 150 browser in the form of a webpage with various functionality contained therein. The webpage may be constructed using conventional browser frames and designate each such frame with a representative tab 310, 360, 370 at the top of the webpage frame. The frame tabs 310, 360, 370 permit the merchant 150 to easily navigate between various functional webpages associated with the Merchant Interface 200. For example, the main webpage that the merchant may access upon logging into his or her account is the Home webpage shown in FIGS. 3A-3D, which preferably includes a list of active prizes 320 that the merchant 150 has already submitted to a sweepstakes, a list of pending prizes 330 that the merchant 150 is preparing to submit to a sweepstakes, the functionality to add a prize 340 to the list of pending prizes 330 for the sweepstakes, and a list of prior prize winners 350 of the merchant's 150 sweepstakes prizes. Other framed tabbed webpages shown in FIG. 3A may include a My Profile webpage 360 (not shown) where the merchant 150 can setup a preferred user profile, and a webpage 370 (not shown) enabling the merchant 150 to logout of his or her account (and hence the Merchant Interface 200).

Assuming that the merchant 150 has elected to access the Home webpage 310 shown in FIGS. 3A-3D, as noted there is a variety of information and functionality available to the merchant 150. One such item of information is a list of active prizes 320, which is preferably displayed as an HTML table. It should be noted that the list 320 shown in FIG. 3A is merely representative and any relevant information can be identified in the table 320, and the list 320 may be depicted anywhere on the webpage that may be desirable.

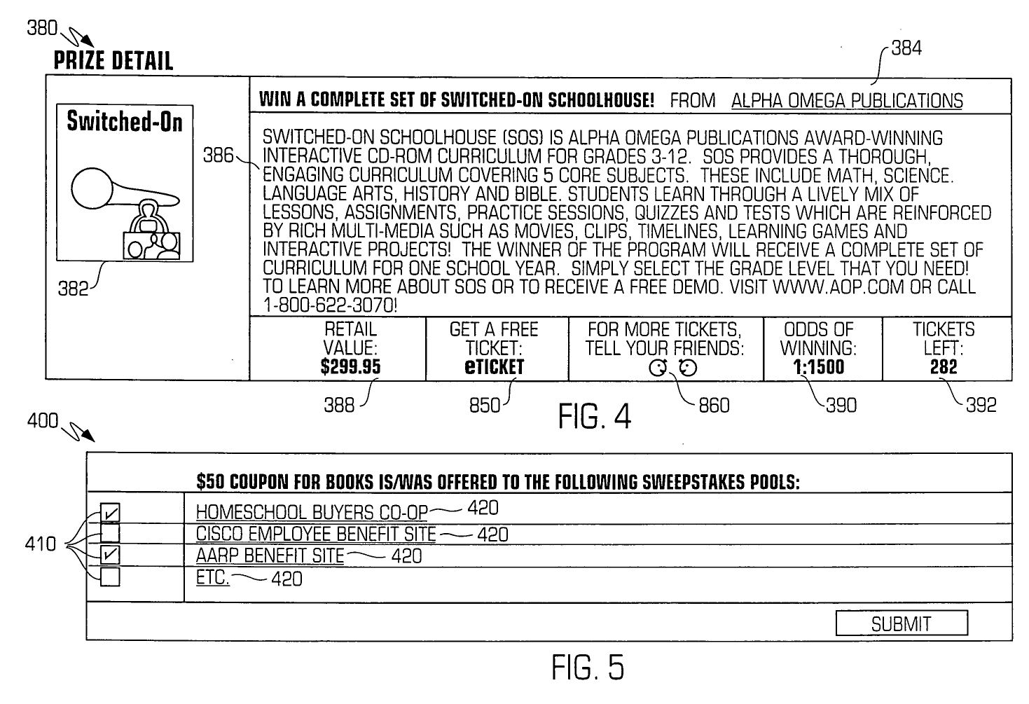

As shown, the Active Prizes table 320 contains seven columns of information 321-327 pertaining to a particular merchant's 150 prize that is currently being offered in a sweepstakes. For example, the name of the prize may be indicated in the leftmost column 321 of the table 320, which in FIG. 3A is entitled “Prizes.” Preferably, the prize is indicated in the table 320 as a dynamic HTML link so that the merchant 150 can navigate to a separate webpage (as shown in FIG. 4) that provides details about the particular prize. The remaining columns 322-327 of the exemplary table 320 in FIG. 3A, read from left to right, are indicated as a “Total Tickets” column 322, a “Total Visits” column 323, a “Total Ticketed Visits” column 324, a “Total Referrals” column 325, a “Tickets Issued” column 326, and a “Tickets Left” column 327. In the particular example shown in FIG. 3A, for the “Win a Complete Set of Switched-On Schoolhouse!” sweepstakes prize, the Active Prizes table 320 indicates that the merchant 150 has authorized the issuance of 1,500 prize tickets, there have been 1,882 visits to the merchant's 150 website, 989 of which represent visits to the merchant's 150 website which generate the issuance of a prize ticket to the visitor. The Active Prizes table 320 also indicates that the merchant's 150 prize entry in the sweepstakes has been referred to 174 individuals, that 1,163 prize tickets have been issued for the sweepstakes, and that 337 of the 1,500 prize tickets for this sweepstakes prize remain. As indicated in FIG. 3A, the number of total visits to the merchant's 150 website being tracked by the software 170 tracks the total number of visits by participants 110 from the sweepstakes to the merchant's 150 site, and that not all of these visits will cause a participant 110 to receive a prize ticket, which explains why the total number of visits may be greater than the number of ticketed visits.

As noted, FIG. 4 illustrates another exemplary portion of the user interface associated with FIG. 3A that may be presented to a merchant as a preview of a prize in advance of submitting it into a sweepstakes. In the exemplary webpage 380 shown in FIG. 4, the prize detail information for the Switched-On Schoolhouse sweepstakes prize is displayed. The webpage 380 preferably includes a graphic of the prize 382, such as is shown on the left side of the webpage 380, and a set of information describing aspects of the prize in detail.

For example, an HTML link 384 may be provided and associated with the sponsor or merchant 150 offering the prize. By selecting the link 384, a user may be navigated to the sponsoring merchant's webpage. There may also be provided a textual description 386 about the details of the prize as well as an indication 388 of its retail value.

In addition, functionality may be included in the webpage 380 that permits a participant 110 to earn at least one prize ticket for the sweepstakes prize displayed on the webpage 380, by for example, clicking on or otherwise selecting the eTICKET logo 850 or refer-a-friend logo 860 associated with the sweepstakes prize displayed on the webpage 380 (the issuance of prize tickets is described in more detail below with reference to the Participant Interface 210). Other information that may also be provided on the sweepstakes prize detail webpage 380 may include information related to the odds of winning the prize 390 as well as an indicator of the number of available prize tickets remaining 392 for the sweepstakes prize.

Returning again to exemplary FIG. 3A, beneath the Active Prizes table 320 on the Home webpage 310 is shown the Pending Prizes table 330 which preferably lists the current prizes that the merchant 150 has added, but not yet published, to a particular sweepstakes. Like with the Active Prizes table 320 the Pending Prizes table 330 is preferably constructed as an HTML table, however, the location and information contained in the list of pending prizes 330 is not limited to the presentation shown in FIG. 3A, and any relevant information can be identified in the table 330, and the list 330 may be depicted anywhere on the webpage that may be desirable.

As shown, the Pending Prizes table 330 preferably contains three columns 331, 332, 333 of information pertaining to a particular merchant's 150 prize that has currently been added by a merchant 150 to the database 160 but not yet published to a sweepstakes. For example, the name of the prize may be indicated in the leftmost column 331, which in FIG. 3A is entitled “Prizes.”The remaining columns of the exemplary table 330 in FIG. 3A, read from left to right, are indicated as a “Total Tickets” column 332, and an “Action” column 333. The Action column 333 has a number of functions that may be associated with it, such as previewing the sweepstakes prize (a preview is accessible by selecting the “Preview” link 334 in the Action column 333 of the Pending Prizes table 330, and shown in FIG. 4), editing the sweepstakes prize (prize information can be edited by selecting the “Edit” link 335 in the Action column 333 of the Pending Prizes table 330 which causes the “Add A Prize” form (described below) to be populated with the information respecting the selected prize, which may then be edited), publish the pending sweepstakes prize to an active sweepstakes (a prize may be published by selecting the “Publish” link 336 in the Action column 333 of the Pending Prizes table 330), copy the pending prize which creates another pending prize record in the database 160 (a pending prize may be copied by selecting the “Copy” link 337 in the Action column 333 of the Pending Prizes table 330), and deleting the pending prize which removes the prize information from the database 160 (a pending prize may be deleted from the database by selecting the “Del” link 338 in the Action column 333 of the Pending Prizes table 330).

FIG. 3A also depicts a Prize Winners table 350 that identifies the winners of a merchant's 150 prior sweepstakes prizes. The Prize Winners table 350 is preferably set forth as an HTML table, and includes nine columns 351-359 of information pertaining to a particular merchant's 150 prize that has been previously won by a participant 110. For example, the name of the prize may be indicated in the leftmost table column 351, which in FIG. 3A is entitled “Prizes.” The remaining columns 352-359 of the exemplary table 350 in FIG. 3A, read from left to right, are indicated as a “Retail Value” column 352, a “Total Tickets” column 353, a “Date Won” column 354, a “Winner's Name” column 355, a “Winner's E-mail” column 356, a “Total Referrals” column 357, a “Total Visits” column 358, and an “Action” column 359.

As shown in FIG. 3A, the name of the prize is preferably indicated as an HTML link 390. Thus, by clicking the appropriate HTML link 390 a merchant's 150 browser is navigated to a Prize Detail webpage (FIG. 4). Alternatively, clicking the appropriate HTML link 390 allows a merchant 150 to review a list of sweepstakes 400 to which he or she had previously offered a prize, such as is shown in FIG. 5. A similar list might be displayed upon the merchant selecting an appropriate HTML link associated with a particular prize in any prize table 320, 330, 350. It is expected that the column heading for the list 400 may vary depending on whether the sweepstakes is ongoing or completed. Preferably, once a merchant 150 has submitted a prize to a sweepstakes it cannot be withdrawn, unless no prize tickets have been issued for that prize. Thus, in a preferred implementation the check boxes 410 shown to the left of the Sweepstakes webpage links 420 in FIG. 5 cannot be unchecked. However, a merchant 150 could use this aspect of the Merchant Interface 200 to contribute a prize to a current sweepstakes simply by checking the appropriate check box 410 or otherwise causing an equivalent selection mechanism to be utilized.

Returning to the Prize Winners table 350 in FIG. 3A, the “Retail Value” column 352 specifies the retail value for the prize that has been won. The “Total Tickets” column 353 identifies the number of prize tickets that were issued for that particular sweepstakes. The “Date Won” column 354 details the date and time the prize was won by a particular participant 110.

The “Winner's Name” and “Winner's E-mail” columns 355, 356 set forth the identity and contact information of the prize winner. The “Total Referrals” column 357 sets forth the total number of referrals to the merchant's 150 website that participants 110 provided to their friends for the particular sweepstakes. The “Total Visits” column 358 identifies the total number of visits that were made to the merchant's 150 website as a result of the sweepstakes. Finally, the “Action” column 359 includes functionality that permits a merchant 150 to create a copy of a previously won prize and populate the “Add A Prize” form (described below) with that information so that the prize can be readily republished into the sweepstakes pool, with or without modification. The “Action” column 359 may also contain a “Print” link (not shown) that upon selection would permit the merchant 150 to print the information associated with that particular prize.

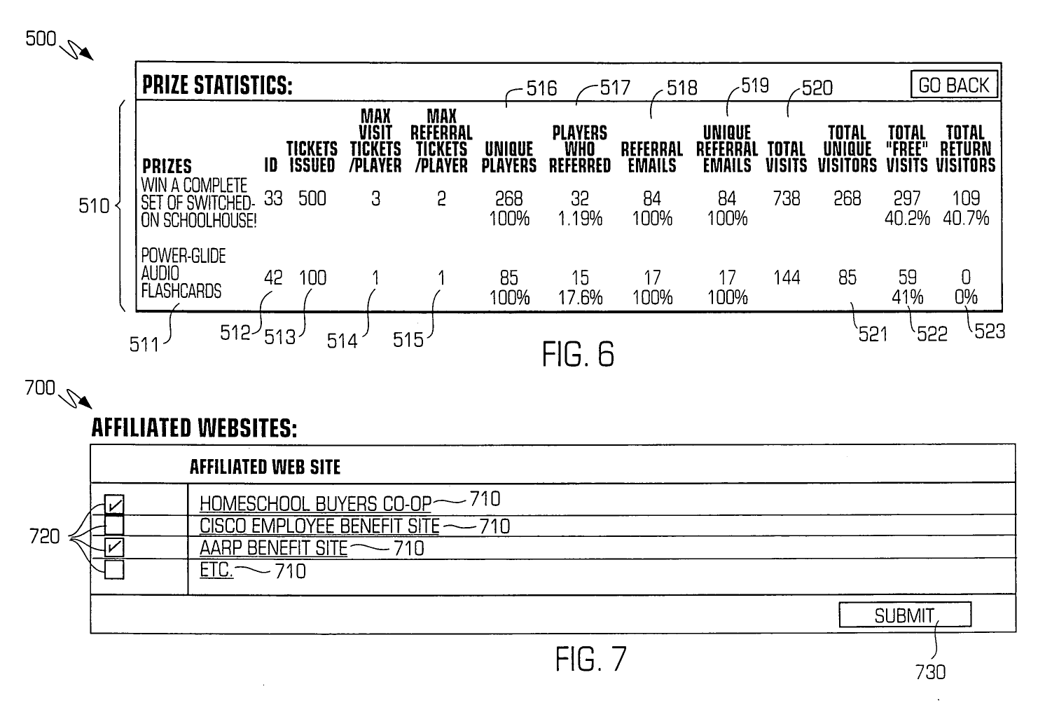

Additional statistics about each sweepstakes is preferably maintained by the system and can be reviewed by the merchant 150, for example, by selecting the “More Statistics” HTML link 392 associated with the Prize Winners table 350. Upon selecting this link 392 statistics pertaining to the prize and participant 110 behavior with respect to that prize can be reviewed. FIG. 6 depicts an exemplary statistics screen 500 that may be displayed. Preferably, the statistics shown on the screenshot 500 are displayed in an HTML table 510 (referred to as Prize Statistics in the exemplary figure) that contains various details about a particular sweepstakes prize.

For example, the leftmost column 511 of the prize statistics table 510 may include the name of the sweepstakes prize offered, such as “Win A Complete Set of Switched-On Schoolhouse” or “Power-Glide Audio Flashcards.” Another column 512 of the prize statistics table 510 may identify the internal prize tracking number maintained in the database 160. Other columns 513-515 of the prize statistics table 510 may include information about the number of tickets issued for the sweepstakes, as well as the maximum number of tickets issued to a participant 110 for visits to and referrals to the merchant's 150 website. Other information that could be presented in the prize statistics table 510 may include information about the number of unique participants 110 in a particular sweepstakes 516 (i.e., the number of unique participants 110 in the sweepstakes), the number of participants 110 referring acquaintances to the merchant's 150 website via the sweepstakes 517, the number of referral e-mails generated by the system 518, and how many of those are unique referrals 519, meaning that any duplicate e-mail addresses for such referrals are ignored. The number of website visits can also be tracked by, for example, total website visits 519, whether or not such visit earned a prize ticket 520, total unique website visits 521 (i.e., the total number of unique participants 110 visiting the website in order to try to win the prize), the number of “free” website visits 522 (i.e., the total number of website visits that did not result in the issuance of a prize ticket), and the number of return visitors to the site 523 (i.e., the number of participants 110 receiving prize tickets for visiting the website more than once).

In exemplary FIGS. 3B-3D, on the tabbed Home webpage 310 is shown the “Add A Prize” template form 340 which permits a merchant 150 to add a record of a sweepstakes prize to the database 160. The “Add A Prize” template form 340 is preferably presented as an HTML form so that the merchant 150 can enter information into the template form 340 and after selecting the “Save to Pending Prizes List” button 610 at the top right side of the “Add A Prize” template form 340 the prize information will be maintained as a unique record entry in the database 160. As with the Active Prizes and Pending Prizes tables 320, 330, the location and information contained in the “Add A Prize” form 340 is not limited to the presentation shown in FIGS. 3B-3D, and any relevant information can be identified, and the form may be depicted anywhere on the webpage that may be desirable.

The “Add A Prize” form 340 preferably contains the following classes of information: prize title, prize description, prize image URL, prize image file, prize keywords, total tickets, visit tickets, referral tickets, retail value, publish to, consolation message, URL for ticket, URL for more information, contact name, supplier name, telephone, e-mail address, notes, cutoff date and time, and duration. Each of these classes of information is described in more detail in the following paragraphs.

In exemplary FIG. 3B, the “Add A Prize” form 340 begins with a field 611 that prompts the merchant 150 for the prize's title, such as the name of the prize. Following the prize title, the “Add A Prize” form 600 presents a prize description field 612 that permits the merchant 150 to enter a description of the prize. Preferably, a maximum of 400 characters (including spaces) may be used to describe a prize. Image information pertaining to the prize may be included by the merchant 150 by inserting a URL for the prize image in the appropriate form field 613 and, if desired, inserting an image file name in the “Prize Image File” field 614. Generally, a merchant 150 who desires to host his or her own prize image will utilize the prize image URL field 613, while merchants 150 who desire a third party to host the prize image on their behalf may utilize the prize image file field 614. Preferably, the maximum image width is set to 125 pixels.

The merchant 150 may also add a list of prize keywords in the appropriate text field box 615. Preferably, multiple keywords can be used to best describe a particular prize provided they are separated in the field box 615 by semicolons or other designator. Keywords can be helpful to focus a participant's 110 search for prizes in multiple sweepstakes. The “Add A Prize” form 340 also permits the merchant 150 to identify the number of total tickets to be issued for his or her particular prize, for example by selecting a predefined number from an appropriate drop down menu 616 or using other equivalent means such as radio buttons or numeric fields. Similarly, a merchant 150 can also identify the number of tickets that can be issued to a participant 110 for visiting the merchant's 150 website, one ticket per visit for example, by selecting a predefined number from an appropriate drop down menu 617 or using other equivalent means such as radio buttons or numeric fields. Preferably, the system can issue one ticket each hour for each visit up to the selected number of tickets (i.e., three tickets in three hours). Similarly, a merchant 150 can also identify the number of tickets that can be issued to a participant 110 for each visit to the merchant's 150 website, which is preferably one but may be more than one, for example by selecting a predefined number from an appropriate drop down menu (not shown) or using other equivalent means such as radio buttons or numeric fields.

As shown in FIG. 3C, a merchant 150 can also identify the number of referral tickets that can be issued to a participant 110 for referring friends to a particular merchant's 150 website, for example by selecting a predefined number from an appropriate drop down menu 618 or using other equivalent means such as radio buttons or numeric fields. Preferably, participants 110 will receive one ticket per referral but may receive more than one ticket per referral by selecting a predefined number from an appropriate drop down menu (not shown) or using equivalent means such as radio buttons or numeric fields. By designating the number of prize tickets that can be awarded to a participant 110 for visiting the merchant's 150 website or for referring friends to the merchant's 150 website, the merchant 150 can thus increase the participant's 110 incentive to participate in the sweepstakes by increasing his or her likelihood of winning the prize since generally there are only a finite and predetermined number of prize tickets issued for each prize. Moreover, the capability to issue prize tickets to participants 110 referring friends allows for viral behavior among target markets and is a particularly advantageous aspect of the preferred embodiment. The number of visit tickets and/or referral tickets can optionally be disabled by selecting or inputting “0” into the appropriate field 617, 618 and similarly for tickets-per-visit and tickets-per-referral in appropriate fields not shown.

The “Add A Prize” form 340 also permits the merchant 150 to input the retail value of the prize in an appropriate form field 619. The merchant 150 can also select the particular affiliated websites in which he or she desires the prize to appear. This can be accomplished, for example, by selecting the appropriate websites from a drop down menu 620 or using other equivalent means such as radio buttons, lists of items with check boxes, or textual fields. Generally, an “affiliated website” is a website that has been properly configured to conduct sweepstakes as described herein, such that any affiliated website can display sweepstakes items offered on any other affiliated website. Website operators or merchants 150 can thus decide whether, and to which, websites they desire to be affiliated. Preferably, the choices available to the merchant 150 for selecting the particular affiliated websites include “all affiliated websites,” “selected affiliated websites,” or “selected, automatically affiliated websites.”

Choosing “all affiliated websites” causes the system to display a list 700 of affiliated websites, such as is shown in exemplary FIG. 7. As shown in FIG. 7, the websites may be presented in the list 700 as HTML links 710 associated with the affiliated website's Sweepstakes webpage, which the merchant 150 can visit by clicking on the appropriate HTML link 710 for the affiliated website. One or more affiliated websites can be chosen by the merchant 150 by indicating or selecting the appropriate checkbox 720 associated with the affiliated websites or using other equivalent selection means. Once the selection of affiliated websites is submitted, for example, by clicking on the Submit button 730 at the bottom of the list 700, the prize may then be posted and displayed simultaneously to the Sweepstakes Page (described below) of all the chosen affiliated websites. Thus, all visits or referrals to the merchant's 150 website from any of the affiliated websites can cause prize tickets to be awarded, and thereby decrement the total number of available prize tickets remaining for the sweepstakes. A prize may be won by any participant 110 visiting or referring user traffic from any affiliated website.

Choosing “selected affiliated websites” causes the system to display a list (not shown) of all affiliated websites to which the current merchant 150 can contribute prizes, such as is similarly shown in FIG. 7 as an exemplary list 700 of all affiliated websites. Upon submission of the appropriate selected affiliated websites, the prize may then be posted and displayed simultaneously on the Sweepstakes Page (described below) of all selected affiliated websites. Thus, all visits or referrals to the merchant's 150 website from any of the affiliated websites can cause prize tickets to be awarded, and thereby decrement the total number of available prize tickets remaining for the sweepstakes. A prize may be won by any participant 110 visiting or referring traffic from any affiliated website.

Choosing “automatically selected affiliated websites” causes the system to display a list (not shown) of all affiliated websites with comparable content based on keywords or popular words and phrases. The prize may be displayed simultaneously on the Sweepstakes Page (described below) of all automatically affiliated websites. Thus, all visits or referrals to the merchant's 150 website from any of the affiliated websites can cause prize tickets to be awarded thereby decrement the total number of available prize tickets remaining for the sweepstakes. A prize may be won by any participant 110 visiting or referring traffic from any affiliated website.

Merchants 150 can contribute prizes to a sweepstakes via the Merchant Interface 200 on any properly configured website. It is expected that most merchants 150 will be strongly associated with individual websites, however, by making the appropriate selection in the Merchant Interface 200, any merchant 150 can elect to have his or her prize contributed to any properly configured and affiliated website.

It should be noted that in alternative embodiments, sweepstakes can be allocated dynamically based on, for example, general website orientation utilizing site keywords or automatic allocation as determined by “crawling” a sweepstakes website to determine website content and affiliating websites with comparable content. For example, in the first case, the manager of a website oriented towards horse trainers could enter a keyword such as “horses” in an appropriate interface and the sweepstakes pool for that website may then be automatically affiliated with any other sweepstakes pool with an identical or similar keyword. In the second case, the sweepstakes manager could elect to let the system automatically assign affiliation based on an analysis of repeatedly occurring words on other websites. So, for example, any website with frequent references to horses on its pages would be automatically affiliated.

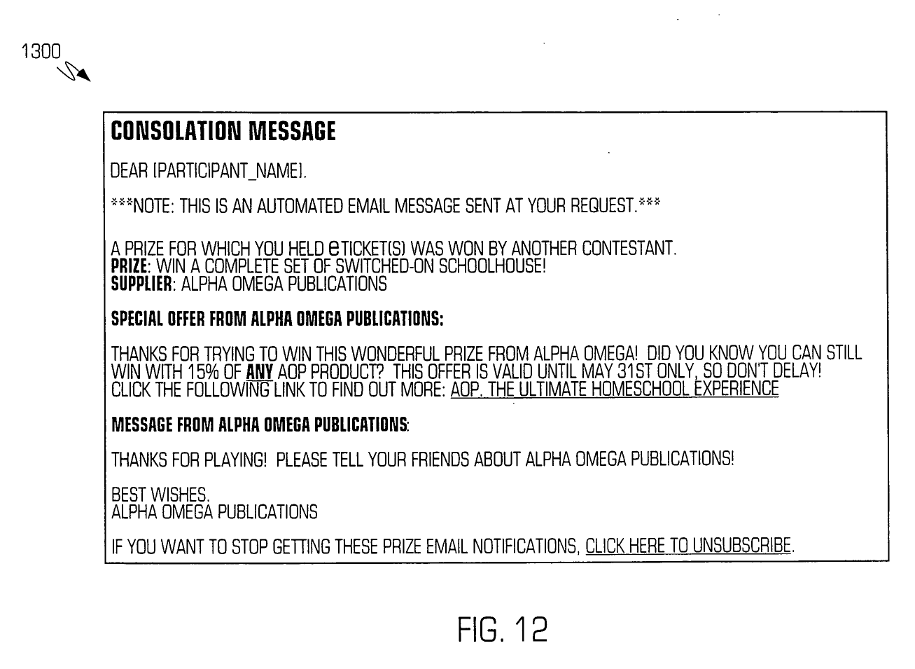

Participants 110 who acquire tickets for any prize have demonstrated an interest in the prize and may therefore be considered qualified leads, or prospective customers, of the offering merchant 150. When a prize is won by random selection at the appropriate time there will be one automatic winner and multiple non-winners. Using the Add A Prize form 340, merchants 150 can elect to send a message to the non-winners in the hope of converting those qualified leads to paying customers, for example by entering a consolation message into an appropriate field 621 in the “Add A Prize” form 340 which can be electronically transmitted to the e-mail address, cell phone, or other communication device of every participant 110 that did not win the prize during the sweepstakes. Preferably, the consolation message may permit HTML-related messaging information so that the message can be fully customized in accordance with the preferences of the merchant 150. An exemplary consolation message is shown in FIG. 12 and described in more detail below.

The “Add A Prize” form 340 also allows the merchant 150 to identify the website URL that participants 110 must visit in order to receive a prize ticket for the sweepstakes. Preferably, the website URL is entered into a text field 622 in the “Add A Prize” form 340 such as the one shown in FIG. 3C. The merchant 150 may also specify in an appropriate text field 623 a website URL that participants 110 may visit to learn more information about the merchant's 150 product or company. Generally, the merchant's 150 company name is linked to this website URL, however, any appropriate website URL can be supplied in this field 623.

As shown in FIG. 3D, the “Add A Prize” form 340 also contains several text fields 624-627 for entering specific information about the merchant 150. Examples of this information can include the contact name for a person associated with the merchant's 150 organization that is to be notified when a winner of the sweepstakes is selected, a supplier name which is usually the company name or the company that is offering the prize, the telephone number of a person at the merchant's 150 organization that should be notified when a winner is selected, and the e-mail address of a person at the merchant's 150 organization that should be notified when a winner is selected. Preferably, this contact information is provided to the sweepstakes winner so that contact can be made between the merchant's 150 designated person and the sweepstakes winner.

The “Add A Prize” form 340 also preferably contains a “Notes” field 628 which enables the merchant 150 to optionally include a message to be sent with the winning e-mail notification to the merchant's 150 representative specifying, for example, how to process the prize, prize redemption information and any other relevant information pertaining to the prize.

By default, prizes are preferably won by immediate, automatic random draw from among the pool of prize ticket holders when the last available prize ticket has been issued. In the event that all available prize tickets have not been issued by a particular deadline, the merchant 150 may force a random draw from among the prize tickets issued at the instant of the deadline. The “Add A Prize” form 340 preferably includes date and time fields 629, 630 which allow the merchant 150 to specify a particular date and time for the prize to be awarded in the sweepstakes as opposed to waiting until a threshold number of prize tickets have been issued. Preferably, date information is entered into the appropriate date field 629 in the format MM/DD/YYYY and time is entered into the appropriate time field 630 in the format HH:MM AM/PM. As noted, if the merchant 150 elects to include a designated date and time at which to award the prize the winner will be randomly selected from among all of the ticket holders at that particular moment. If all of the specified prize tickets have been issued for a particular sweepstakes and the merchant 150 has also specified a particular date and time for which to select a winner, the prize is preferably awarded before the specified date and time, and at such time as when the final prize ticket has been awarded.

The merchant 150 may also elect to cause the system to automatically publish a duplicate prize into the sweepstakes pool each time the prior identical prize has been won by a participant 110. A merchant 150 electing for perpetual prizes may select this option by checking the appropriate duration checkbox 631 or utilize other equivalent identifier means on the “Add A Prize” form 340. This allows a merchant to maintain one or more prizes in one or more sweepstakes, in perpetuity, with no effort beyond the initial configuration of the prize, until such time that the merchant terminates this feature.

At any period during the filling out of the “Add A Prize” form 340 the merchant 150 can choose to save the form information to the database 160 which causes a record to be populated into the centralized prize database 160 containing at least the information that the merchant 150 has entered into the “Add A Prize” form 340 about that prize. This can be accomplished, for example, by selecting the “Save to Pending Prizes List” button 610 which in exemplary FIGS. 3B-3D is designated at the top and bottom of the “Add A Prize” form 340 for convenience.

Thus, the Merchant Interface module 200 can be used to display the following information for the merchant 150 and permit the merchant 150 with certain designated functionality to interact with the software 170: the prizes currently in a sweepstakes (active prizes); prizes being prepared for the sweepstakes, but not yet published into the pool (pending prizes); an input form by which to add and configure prizes (Add A Prize); and prizes previously in the sweepstakes that were won by participants (prize winners).

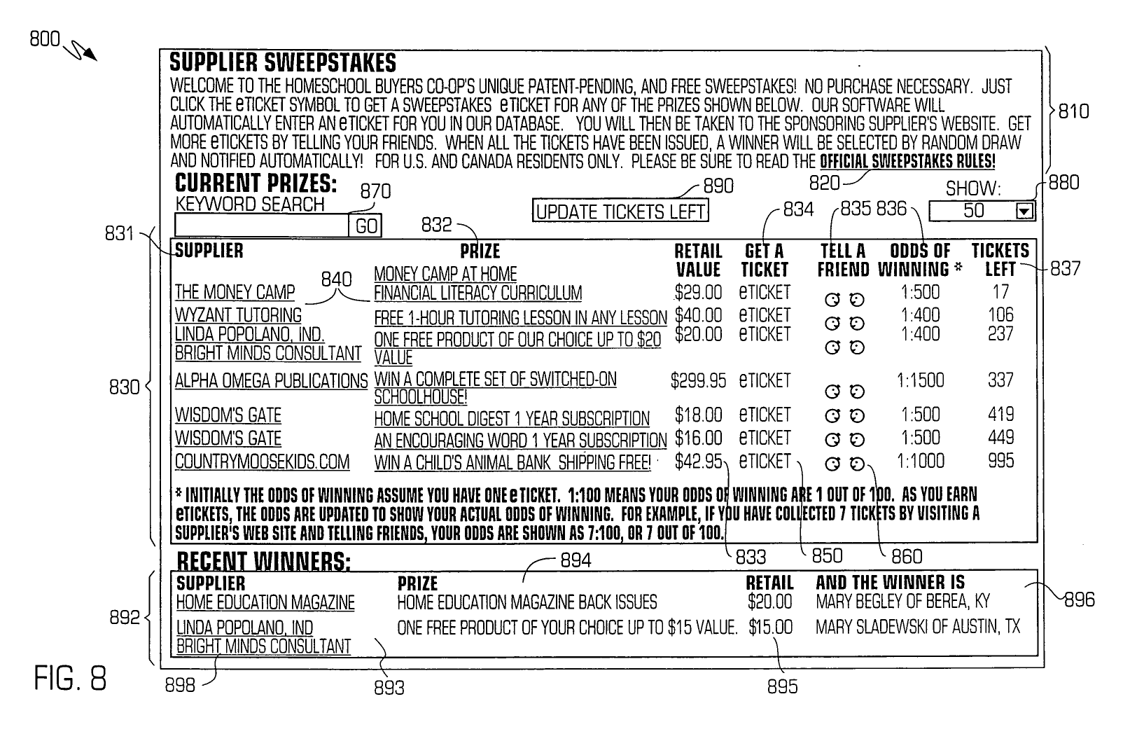

FIG. 8 is an exemplary screen shot 800 of a Sweepstakes webpage that may be displayed on a participant's 110 web browser, cell phone, or other wired or wireless device depicting the Sweepstakes webpage for the Homeschool Buyers Co-op. As noted, participating and properly configured websites may display Sweepstakes webpages similar to that shown in FIG. 8. Those skilled in the art will recognize that this webpage is simply representative and other Sweepstakes webpages may be configured different from that shown in FIG. 8 without departing from the scope of the invention. For example, a different configuration might permit a list of sweepstakes prizes to be displayed more compactly in one or the other margin of a webpage, or scrolling across a webpage in ticker-tape fashion, or appearing and disappearing dynamically in pop-up windows based on user movements of a mouse or other input device. This screenshot 800 may be generated from the Participant Interface module 210 of the software 170 executing on the server 180.

As shown in FIG. 8, the top of the webpage 810 may contain instructions or other informational material for those participants interested in the sweepstakes. These instructions may or may not contain a link 820 to a separate webpage (not shown) outlining official sweepstakes rules. Below the informational material 810, the Sweepstakes webpage may detail a table 830 of various sweepstakes prizes currently being offered in the sweepstakes. For example, in FIG. 8, seven different prizes constitute the sweepstakes pool for the Homeschool Buyer's Co-op. The actual number of prizes that can be offered in a particular sweepstakes is limitless.

The sweepstakes table 830 is preferably depicted as an HTML table with a variety of rows and columns. Each row in the table 830 specifies a unique prize in the sweepstakes pool, whereas each column identifies specific information about that particular prize. In the example shown in FIG. 8, the sweepstakes prize pool table 830 may include a leftmost column 831 that specifies the supplier or merchant 150 of a particular prize. The next column 832 may indicate the name of the prize being offered. Preferably, each of the supplier and prize columns implement dynamic HTML linking so that a participant 110 can click or select the appropriate HTML link 840 and navigate to a separate webpage (not shown) associated with the particular link 840 and learn more information about the supplier and/or prize being offered.

The sweepstakes table 830 may specify the retail value 833 of the prize being offered. More importantly, via the sweepstakes table 830 a participant 110 can elect to acquire a prize ticket for a particular prize by, for example, selecting the eTICKET logo 850 associated with that prize in the “Get A Ticket” column 834. Optionally, the participant 110 may elect to earn additional prize tickets for a particular prize by electing to refer the merchant's 150 website to a friend, for example, by selecting the appropriate logo 860 in the “Tell A Friend” column 835 of the sweepstakes table 830. The sweepstakes table 830 may also indicate the odds of winning a particular sweepstakes prize 836 as well as indicate the number of prize tickets remaining for a particular prize 837.

There may be a key term search capability provided on the Sweepstakes webpage, such as in the form of a text input field 870 to permit a participant 110 to search for particular prizes of immediate interest by querying for such using an appropriate keyword. In situations where a particular sweepstakes pool has a large number of prizes, an option may be available to a participant 110 to display a certain number of prizes in the sweepstakes at a particular time. For example, in FIG. 8, a drop down menu 880 is provided, the selection of which will update the Sweepstakes webpage display view on the participant's 110 browser to display up to the designated number of prizes on a single webpage. Because the sweepstakes are dynamic, a button 890 or other mechanism may be provided on the webpage to allow the participant 110 to update the number of available prize tickets listed in the prize table 830 for each prize in the sweepstakes in real-time. Upon selection of this button 890 a browser refresh of the Sweepstakes webpage will be caused which will indicate updated ticket information in the resulting “Tickets Left” column 837 of the sweepstakes table 830.

The Sweepstakes webpage may also indicate, preferably towards the bottom of the webpage, a table 892 of recent prize winners for various prizes in the sweepstakes. For example, in FIG. 8, two prizes are indicated as having already been won by participants 110. The recent winners table 892 may indicate the supplier of a prize 893, the name of the prize won 894, its retail value 895 and information about the prize winner 896, such as the winner's name and city of residence. Preferably, the prize supplier information is provided as a dynamic HTML link 898 so that a particular participant 110 can click on the appropriate link 898 and navigate to a separate webpage (not shown) to learn more information about that particular supplier.

In the example shown in FIG. 8, prize tickets for a particular prize may be earned by the participant 110 clicking the eTICKET symbol 850 or the Tell A Friend logo 860 (or both sequentially) for a particular prize in the sweepstakes pool. Preferably, clicking on the eTICKET symbol 850 will cause the participant's 110 browser to navigate to the merchant's 150 website that was designated for the prize as discussed above with regard to the Merchant Interface 200. Alternatively, upon the user clicking the eTICKET symbol 850 an intermediate pop-up window 900 may be shown to the participant 110 giving him or her more information about the prize and other possible relevant information and then prompting the participant 110 to click through to the merchant's 150 website to earn one or more prize tickets (which will be automatically recorded into the centralized database 160 and associated therein with the participant 110). Examples of such intermediate pop-up windows 900, 910 are shown in FIGS. 8A and 8B.

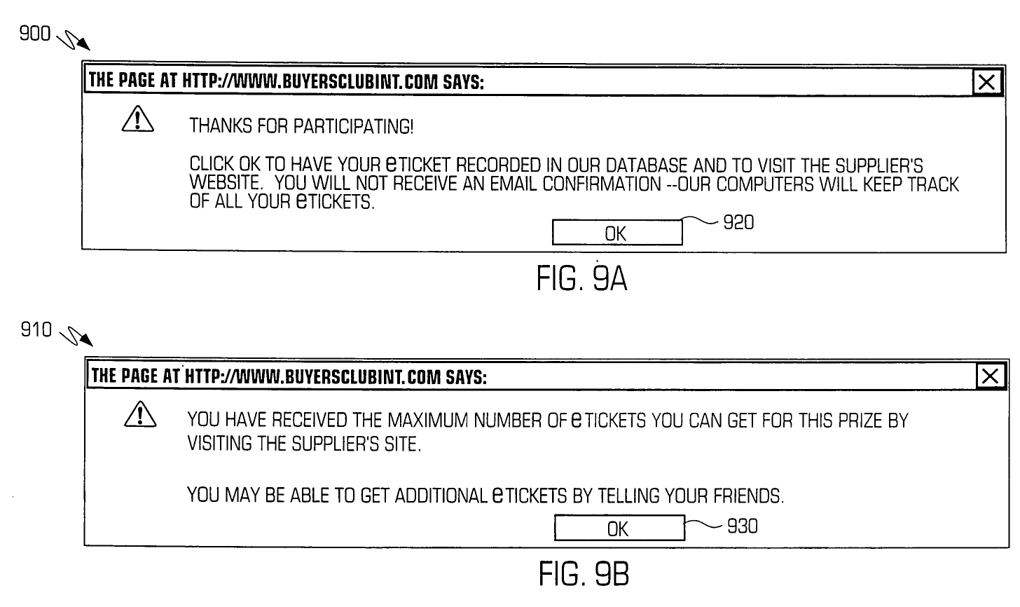

FIG. 9A shows an exemplary view of a confirmatory pop-up window that may be displayed to a participant 110 after electing to acquire a prize ticket for a particular sweepstakes prize, whereas FIG. 9B shows an exemplary view of a pop-up window that may be displayed to a participant 110 after having exceeded a threshold number of prize tickets for a particular prize.

With regard to FIG. 9A, clicking the “OK” button 920 in the pop-up window 900 causes the system to enter or update a database record in the centralized database 160 managing the sweepstakes to record the issuance of a prize ticket to the participant 110, and also causes the participant's 110 browser to be navigated to the merchant's 150 website associated with the prize. The database record entry preferably indicates at least the participant's 110 unique identifying information, the identifying information for the prize, and also the merchant's 150 identifying information. The system also causes the number of tickets remaining in the sweepstakes for the prize item to be decremented and subsequent webpages displaying that number can be updated to indicate the participant's 110 true odds of winning the prize (based on the number of tickets issued and the number of tickets earned). Alternatively, the participant 110 could propagate through multiple webpages in order to earn a ticket which could allow for additional marketing efforts, such as filling out a survey, or registering for a free membership at the target website, to a captive group of users. With regard to FIG. 9B, clicking the “OK” button 930 in the pop-up window 910 causes the participant's 110 browser to navigate to the merchant's website, thereby essentially affording the merchant 150 a “free” visit, as described earlier.

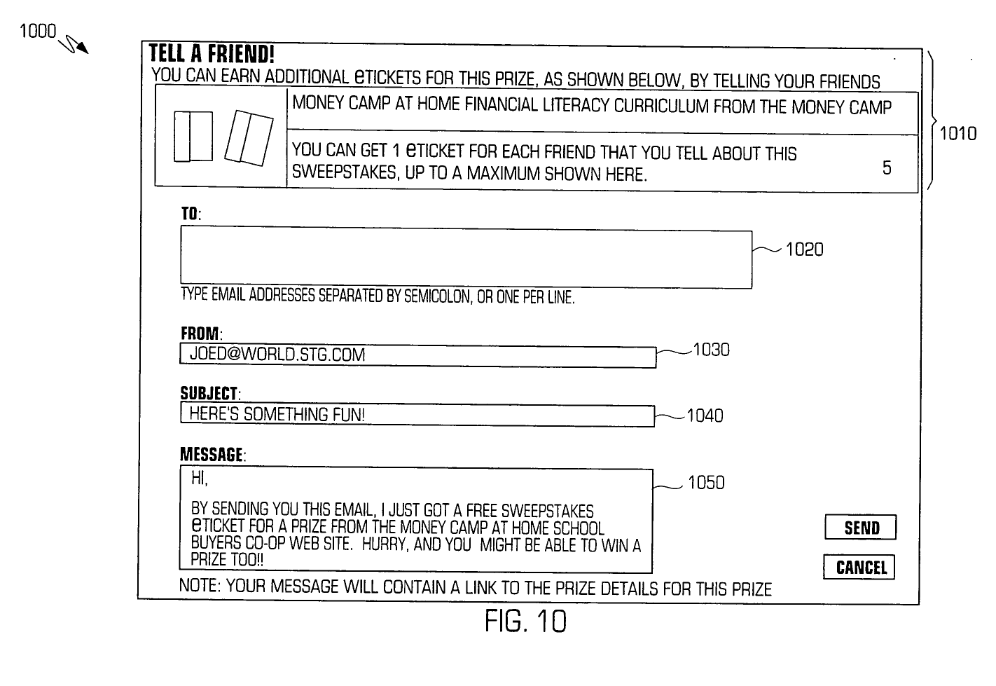

If a participant 110 chooses to refer a friend to the merchant's 150 website, such as by selecting the Tell A Friend logo 860 for a particular prize in exemplary FIG. 8, the system may respond by providing the participant 110 with a webpage 1000 on which the participant 110 can enter various information about his or her friend, such as e-mail, cell phone number, and other designations for electronic communication with those friends. A representative webpage 1000 for referring a friend to the merchant's 150 website is shown in FIG. 10.

As shown in FIG. 10, the refer-a-friend webpage 1000 may include a top portion 1010 that specifies some information about the prize and sponsor, as well as indicates the number of prize tickets that have been authorized for participants 110 who elect to refer their friends. For example, in FIG. 10, the prize for which a participant 110 has elected to refer a friend is indicated as “Money Camp at Home Financial Literacy Curriculum” and the sponsor of the prize is “The Money Camp.” Also indicated in FIG. 10 is the number of prize tickets the sponsor has authorized for referring friends to the website, in this case up to five e-Tickets can be issued to an individual participant 110 (one earned for each of five friends referred).

The refer-a-friend webpage 1000 also preferably contains various fields 1020-1050 typical of those used in traditional e-mail tools, such as a “To” field 1020 for specifying e-mail addresses of one or more friends to e-mail the referral (preferably, multiple e-mail addresses can be specified, each separated by a semicolon in the field 1020), a “From” field 1030 indicating the e-mail address of the participant 110 referring a friend, a “Subject” field 1040 which permits the participant 110 to enter a subject for the e-mail message, and a “message” field 1050 which specifies certain information pertaining to the referral. After filling out the appropriate fields 1020-1050, the participant 110 can elect to have the system transmit the electronic message to the recipient(s) identified in the “To” field 1020 on the participant's 110 behalf by clicking on the “Send” button 1060 on the refer-a-friend webpage 1000. The system also can then credit the participant 110 (sender) with the appropriate number of prize tickets and record such in the centralized database 160.

The software 170 also utilizes a Sweepstakes Manager Interface module 220 to assist in managing a sweepstakes on a particular website. Typically, a sweepstakes manager will be responsible for managing the sweepstakes. The sweepstakes manager could be an individual employee of the merchant 150, or could be someone associated with the merchant's 150 organization whose responsibilities, in part, include managing the one or more sweepstakes websites for the organization. Typically, the sweepstakes manager will be a sponsor or someone who manages a sweepstakes on behalf of a sponsor (i.e., the owner or operator of a website that desires to display a sweepstakes on his or her site; such a site is ordinarily referred to as a “sponsoring site”).

Similar to the Merchant Interface module 200, the Sweepstakes Manager Interface module 220 can be used by sweepstakes managers to manage sweepstakes, for example on their own or affiliated websites, such as to add, modify, copy or delete various sweepstakes pools. Using his or her personal computer or other communications device, a sweepstakes manager may access the server 180 and interact with the Sweepstakes Manager Interface module 220 of the software 170. FIGS. 10A and 10B are exemplary screen shots of portions of a user interface 1100 that may be displayed to a sweepstakes manager via the Sweepstakes Manager Interface 220.

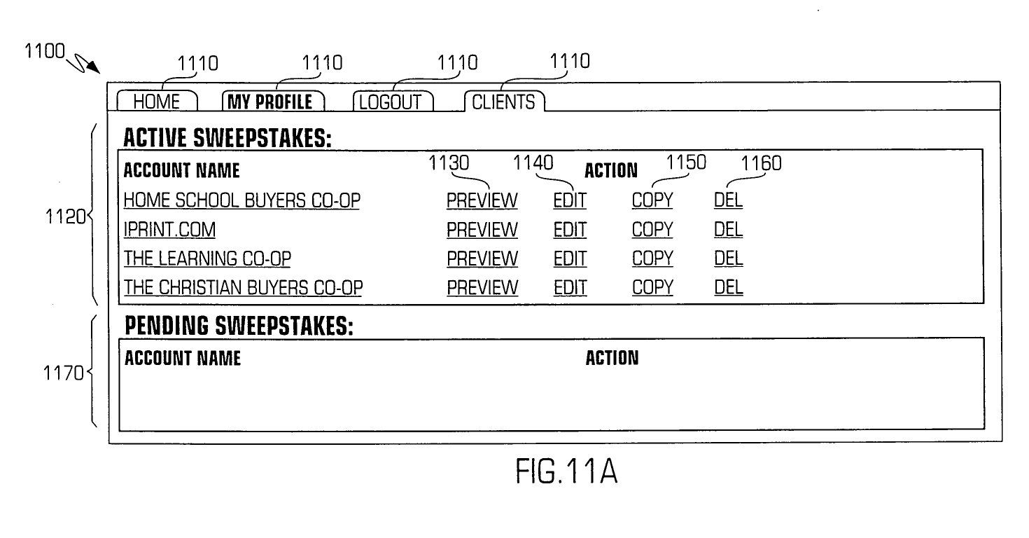

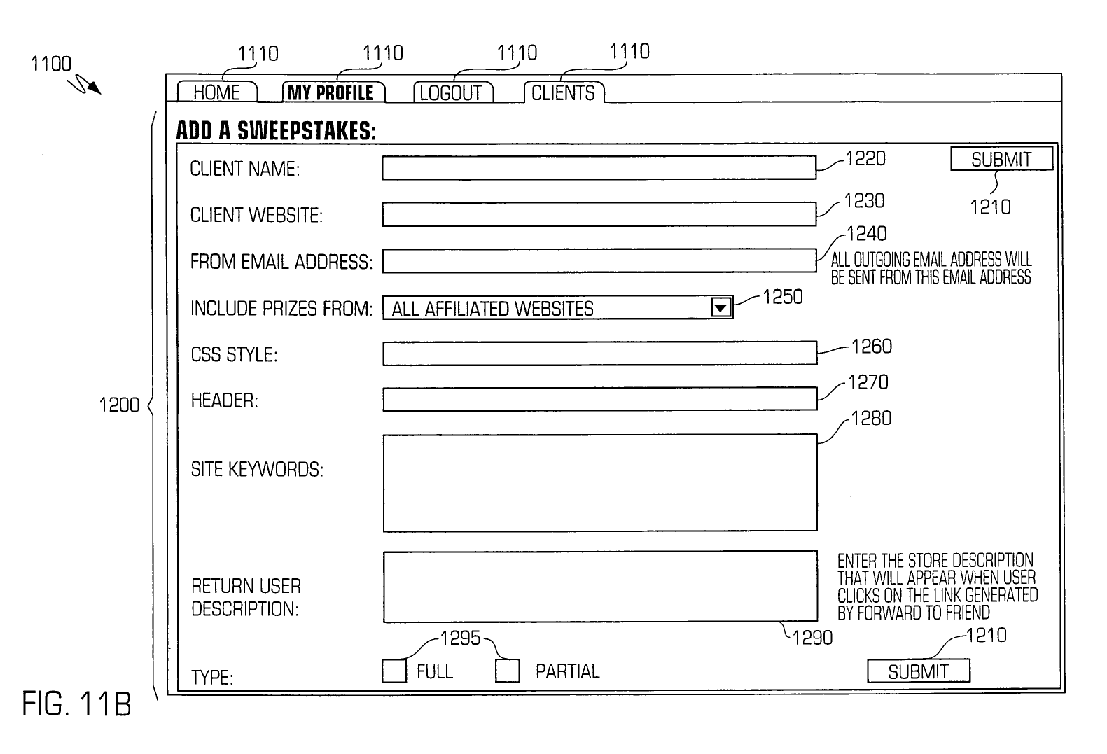

Referring to FIG. 11A, the Sweepstakes Manager Interface 220 may be represented on a sweepstakes manager's browser in the form of a webpage. The webpage may be constructed using browser frames with various functional tabs 1110 at the top of the webpage representing different associated framed webpages with certain information and functionality associated therewith. For example, the Clients webpage (shown) preferably includes a list of active or pending sweepstakes 1120, 1170, and the functionality to add a new sweepstakes to a website 1200. Other functionally tabbed webpages shown in FIG. 11A may include a My Profile webpage (not shown) where the sweepstakes manager can setup a preferred user profile. Alternatively, a Logout webpage (not shown) permits the sweepstakes manager to logout of his or her account. Preferably, the Sweepstakes Manager Interface module 220 is programmed with PHP, JAVA, C+, C++, PERL, JAVASCRIPT or any programming language which allows for a streamlined user interface presentation in a sweepstakes manager's browser. The particular user interface display shown in FIGS. 10A-10B is exemplary as any type of information can be chosen by the designer for display in the user interface, to the sweepstakes manager.

Assuming that the sweepstakes manager has elected to access, review and/or interact with the Client webpage 1100 shown in FIG. 11A, there is a variety of information available to the sweepstakes manager. One such piece of information may be reviewing a list of active sweepstakes 1120, such as is shown near the top of the Clients webpage 1100 in FIG. 11A. It should be noted that the location and information contained in the list of active sweepstakes 1120 is not limited to the presentation shown in FIG. 11A, and any relevant information can be identified, and the list 1120 may be depicted anywhere on the webpage that may be desirable.

The list of active sweepstakes 1120 preferably identifies the current sweepstakes that the sweepstakes manager is responsible for managing, and for each such sweepstakes various functions may be available to the sweepstakes manager, such as previewing the sweepstakes (by selecting the preview link 1130 associated with the sweepstakes), editing the sweepstakes (by selecting the appropriate edit link 1140), copying or deleting a particular sweepstakes (by selecting the appropriate link 1150, 1160 associated with the sweepstakes).

A list of pending sweepstakes 1170 which have not yet been activated may also be provided to the sweepstakes manager. The list of pending sweepstakes 1170 is preferably configured similarly to the active sweepstakes list 1120 and similar functionality is preferably available to the sweepstakes manager for the pending sweepstakes as is available for the active sweepstakes. In exemplary FIG. 11A, there are no current pending sweepstakes shown.

Importantly, the sweepstakes manager can add a new sweepstakes by interacting with the “Add A Sweepstakes” form 1200 that is provided in the Clients page 1100 as shown in FIG. 11B. The “Add A Sweepstakes” form 1200 is preferably presented as an HTML form so that the sweepstakes manager can enter information into the form 1200 and after selecting the “Submit” button 1210 at the top or bottom right side of the form 1200 the sweepstakes information can be posted to the appropriate server 180 via the Sweepstakes Manager Interface 220 and maintained as a record entry in the centralized database 160. As with the active and pending sweepstakes lists 1120, 1170, the location and information contained in the “Add A Sweepstakes” form 1200 is not limited to the presentation shown in FIG. 11B, and any relevant information can be identified, and the form 1200 may be depicted anywhere on the webpage that may be desirable.

The “Add A Sweepstakes” form 1200 preferably contains the following classes of information: client name, client website, an originating e-mail address, which websites will supply prizes to the sweepstakes, a CSS style for the sweepstakes, header information, website keywords, description information about merchants, and the type of sweepstakes. Each of these classes of information are described in more detail in the following paragraphs.

In exemplary FIG. 11B, the “Add A Sweepstakes” form 1200 begins with a field 1220 that prompts the sweepstakes manager for the client's name, such as the name of the sponsoring merchant 150 or organization. The client name appears in the list of active and affiliated websites. Following the client name field 1220, the “Add A Sweepstakes” form 1200 may display a client website field 1230 that permits the sweepstakes manager to enter the sponsoring merchant's 150 or organization's website address. The client website is the URL to the webpage on the affiliated website that other sweepstakes managers may visit when deciding whether to affiliate with the current sweepstakes manager's websites. A “From E-mail Address” field 1240 is also provided on the form 1200 which is used as the originating e-mail address for all electronic communications from the sponsor to the participants 110 of the sweepstakes. A Message Manager 230 (described below) preferably facilitates such communications.

The “Add A Sweepstakes” form 1200 further includes a field 1250 that allows the sweepstakes manager to specify from which websites sweepstakes prizes will be included, for example, by selecting the appropriate websites from a drop down menu 1250 or using other equivalent means such as radio buttons or textual fields. Preferable choices involve including prizes from “all affiliated websites,” “selected affiliated websites,” “selected, automatically affiliated websites,” or “no websites.” This is essentially the counterpart to the “Publish To” field 620 in the Merchant Interface 200 as these selections can determine whether a prize will appear on one, any or all available sweepstakes pages. The form 1200 also permits the sweepstakes manager to specify customized CSS styles and header information by entering appropriate data into the appropriate fields 1260, 1270. CSS styles reference a style sheet that is used to control the cosmetic appearance of the sweepstakes page and header references the text for the header that appears on the title bar of the sweepstakes webpage.

The sweepstakes manager may also add a list of website keywords in the appropriate form field 1280. Preferably, multiple keywords can be used to best describe a particular sweepstakes website provided they are separated in the text field 1280 by semicolons or other designator. Keywords can be helpful to characterize the sponsoring website so that it may be automatically affiliated by the system with sweepstakes on other websites. For example, all websites with a common keyword, such as “horses,” would be automatically affiliated. The “Add A Sweepstakes” form 1200 also permits the sweepstakes manager to specify in a designated text field 1290 certain descriptive information about a particular merchant 150 which will be used when an individual clicks on the appropriate HTML link generated by the refer-a-friend function described above (i.e., the introductory information that may appear on the landing webpage for participants 110 clicking through to a sponsoring website from links in their tell-a-friend e-mails.

Finally, the exemplary “Add A Sweepstakes” form 1200 shown in FIG. 11B permits the sweepstakes manager to specify the “footprint” of the sweepstakes by selecting a checkbox 1295 or otherwise indicating whether the sweepstakes being added will be designated as a full sweepstakes or a partial sweepstakes. Preferably, a full sweepstakes typically occupies and entire page on a sponsoring website and offers the full Participant Interface 210 (described above). A partial sweepstakes preferably occupies only a small zone on a website and would typically be used to attract potential participants 110 to a full sweepstakes on the same or different website. It is envisioned that the partial sweepstakes could be run on websites that refer traffic to other websites sponsoring a full sweepstakes in exchange for a commission.

At any period during the filling out of the “Add A Sweepstakes” form 1200 the sweepstakes manager can choose to post the information to the appropriate server 180 and thus save the form information to the database 160 which causes a record to be populated into the centralized prize database 160 containing at least the information that the sweepstakes manager has entered into the “Add A Sweepstakes” form 1200 about that sweepstakes. This can be accomplished, for example, by selecting the “Submit” button 1210, which in exemplary FIGS. 10A and 10B is designated at the top and bottom of the “Add A Sweepstakes” form 1200 for convenience.

When the sweepstakes manager has finished specifying a new sweepstakes, the system is preferably configured to generate and display JavaScript 140 that may be embedded in the programming code of a host webpage in order to enable a sweepstakes to run on the sponsor's webpage. An exemplary form of a JavaScript program 140 that may be generated for a sweepstakes for the Home School Buyer's Co-op may resemble the following:

<script language=”javascript”><!--

raffle_client_id = “1”;
raffle_width = 600;
raffle_height = 2000;
raffle_login = “”;
raffle_keyword = “keyword”;
raffle_text_color = “000000”; //-->

</script>
<script language = “javascript”
src=“http://www.buyersclubint.com/raffle.js”></script>

The JavaScript program 140 shown above is merely representative and other appropriate JavaScript could be automatically generated without departing from the invention. Moreover, the invention may alternatively generate computer instructions other than JavaScript that is configured to enable sweepstakes to run on a webpage.

As noted above, in cases where participants 110 did not win a sweepstakes prize they were competing for, preferably, the merchant 150 can cause a consolation message 1300 to be transmitted to their e-mail addresses to entice such participants 110 to nevertheless visit the merchant's 150 website and possibly purchase the same or additional product or service offerings from the merchant 150. An example of one such consolation message 1300 is shown in FIG. 12.

The software 170 also preferably includes a Message Manager module 230 that monitors changes to the central sweepstakes database 160 and initiates any required notifications to users of the system. Any form of electronic or offline communication can be used to effect this notification, however e-mail is preferred.

A number of database updates can trigger notifications. These include, but are not limited to, the remaining ticket count reaching zero, the selection of a prize winner, and a change in selection of affiliated sweepstakes. When the remaining ticket count for a sweepstakes prize reaches zero, the Message Manager 230 can inform the appropriate software algorithm (not shown) responsible for conducting the sweepstakes drawing, and a prize winner can be subsequently selected at random. When a prize winner is selected, the Message Manager 230 simultaneously notifies the winner and the sponsoring merchant. Additionally, the Message Manager 230 may cause a “consolation” message to be transmitted to the non-winners of the sweepstakes. Finally, when a sweepstakes manager changes his or her selection of affiliated sweepstakes, the Message Manager 230 can notify the affected sweepstakes operators that they have been added (or removed) from the sweepstakes manager's pool so that they can reciprocate (or not) at their option.

An automated method for advertising a merchant's goods or services on-line by offering electronic sweepstakes tickets to interested participants over one or more websites in exchange for either visits by participants to the merchant's website or referrals by participants to other prospective participants via electronic communication has been described in detail herein. Without limitation, such a system and method can be implemented by software executing on one or more computer servers over a computer network, such as the Internet, whereby merchants can enter prizes into an on-line sweepstakes and define advertising rules for the sweepstakes all via a remote system such as a personal computer connected to the Internet. Furthermore, the software can be configured to publish the prizes to one or more sweepstakes with links to merchants' websites on one or more websites for concurrent viewing by multiple participants, each of whom may participate at their leisure via a remote system such as a personal computer or cell phone or other wired or wireless device connecting to the Internet, and to track the real-time status of the sweepstakes on each of the participating websites.

The foregoing has been described with reference to particular figures. While the embodiments described herein are set forth in detail, such descriptions are merely representative of a preferred embodiment and are not intended to be limiting. Rather, the invention can be implemented using a variety of programming and design techniques without departing from the spirit and scope of the invention.

What is claimed is:

1. A software program configured to enable sweepstakes functionality, the software program permitting at least one sweepstakes prize to be included in a sweepstakes game that is integrated with a website that is accessible over a communications network, associating at least one prize ticket to any participant of the sweepstakes who performs a predefined action associated with the sweepstakes prize, and automatically awarding the sweepstakes prize to the one of the participants of the sweepstakes game whom is associated with a winning prize ticket upon the occurrence of a predefined event.

2. The software program of claim 1, wherein the sweepstakes game is integrated with the website via computer instructions that are embedded within the underlying programming code of the website.

3. The software program of claim 1, wherein the computer instructions constitute a Javascript program.

4. The software program of claim 1, wherein the predefined action associated with the sweepstakes prize includes any of accessing a specific website or identifying contact information associated with one or more individuals other than the participant.

5. The software program of claim 4, wherein the contact information includes any of e-mail addresses and telephone numbers of the one or more individuals.

6. The software program of claim 1, wherein the predefined event includes any of the issuance of a predefined threshold number of prize tickets or the satisfying of a predetermined time period.

7. The software program of claim 1, further configured to transmit a consolation message to any participant of the sweepstakes game who did not win the sweepstakes prize.

8. The software program of claim 1, wherein the communications network is a computer network.

9. A system, comprising:
a server computer having a software program resident thereon to enable a sweepstakes game to be integrated into a website that is accessible over a communications network, the software program including functionality that: permits at least one sweepstakes prize to be included in the sweepstakes game; associates at least one prize ticket to any participant of the sweepstakes game who performs a predefined action associated with the sweepstakes prize; and automatically awards the sweepstakes prize to the one of the participants of the sweepstakes game whom is associated with a winning prize ticket upon the occurrence of a predefined event; and
a database associated with the server computer and in electronic communication with the software program such that the database maintains information sufficient to uniquely identify each such participant of the sweepstakes game and associate the prize tickets earned during the sweepstakes game with the appropriate participants such that a winning participant can be randomly chosen upon the occurrence of a predetermined event.

10. The system of claim 9, wherein the sweepstakes game is integrated with the website via computer instructions that are embedded within the underlying programming code of the website.

11. The system of claim 10, wherein the computer instructions constitute a Javascript program.

12. The system of claim 8, wherein the predefined action associated with the sweepstakes prize includes any of accessing a specific website or identifying contact information associated with one or more individuals other than the participant.

13. The software program of claim 12, wherein the contact information includes any of e-mail addresses and telephone numbers of the one or more individuals.

14. The system of claim 9, wherein the predefined event includes any of the issuance of a predefined threshold number of prize tickets or the satisfying of a predetermined time period.

15. The system of claim 9, wherein the software program includes functionality that transmits a consolation message to any participant of the sweepstakes game who did not win the sweepstakes prize.

16. The system of claim 9, wherein the communications network is a computer network.

17. A electronic sweepstakes system, comprising:
a first software algorithm that permits at least one sweepstakes prize to be added to a sweepstakes game associated with a webpage accessible via a communications network;
a second software algorithm that issues prize tickets to one or more participants of the sweepstakes game in exchange for the participant either visiting the website of an offeror of the sweepstakes prize or referring at least one individual other than the participant to the website associated with the offeror; and
a third software algorithm that awards the sweepstakes prize to such participant associated with a winning prize ticket when any of a threshold number of prize tickets have been issued or a predetermined time period occurs.

18. The electronic sweepstakes system of claim 17, further comprising a fourth software algorithm that transmits a consolation message to any participant of the sweepstakes game who did not win the sweepstakes prize.

19. The electronic sweepstakes system of claim 18, wherein the first, second, third and fourth software algorithms comprise a single software program.

20. The electronic sweepstakes system of claim 19, wherein the communications network is a computer network.

21. The electronic sweepstakes system of claim 17, wherein the communications network is a computer network.

22. An electronic game system, comprising:
a software program that permits at least one prize to be included in a game integrated into a particular website that is accessible over a communications network and issues at least one prize ticket to one or more participants of the game in exchange for the participant to either visit the website of an offeror of the prize or refer at least one individual other than the participant to the website associated with the offeror, wherein the prize is awarded to the participant associated with a winning prize ticket when any of a threshold number of prize tickets have been issued or a predetermined time period occurs.

23. The electronic game system of claim 22, wherein a consolation message is sent to any participant of the game who did not win the prize.

24. The electronic game system of claim 22, wherein the communications network is a computer network.

25. An integrated electronic sweepstakes, comprising:
a software program executing on one or more servers over a communications network configured to permit one or more merchants to submit sweepstakes prizes to an on-line sweepstakes and define rules relating to the issuance of prize tickets for and the awarding of such sweepstakes prizes, and to permit one or more participants to interact with the on-line sweepstakes to earn at least one of the prize tickets for any of the sweepstakes prizes such that each of the sweepstakes prizes will be randomly awarded to particular ones of the participants in the sweepstakes based on such participants being associated with a winning prize ticket for the respective sweepstakes prize; and
a database in communication with the software program that is configured to maintain information sufficient to uniquely identify each such participant of the on-line sweepstakes and associate the prize tickets earned during the on-line sweepstakes with the appropriate participants such that a winning participant can be randomly chosen upon the occurrence of a predetermined event.

26. The integrated electronic sweepstakes of claim 25, wherein the software program is accessible via a remote device via the communications network.

27. The integrated electronic sweepstakes of claim 25, wherein the communications network is a computer network.

28. The integrated electronic sweepstakes of claim 25, wherein the sweepstakes prizes for the on-line sweepstakes are displayed on multiple affiliated websites that are different from the website on which the on-line sweepstakes operates.

29. The integrated electronic sweepstakes of claim 25, wherein the software program is further configured to transmit a consolation message to any participant of the on-line sweepstakes who did not win the sweepstakes prize.

30. A method for enhancing user traffic to a particular website, comprising the steps of:
offering at least one prize for which multiple individuals can compete for in an on-line game;
designating a threshold number of prize tickets to be awarded to individuals competing for the prize in the game;
issuing at least one prize ticket to any such individual who either visits a designated website of the prize offeror or refers at least one other individual to the website associated with the offeror; and
randomly awarding the prize to a particular individual associated with a winning prize ticket after the threshold number of prize tickets have been issued.

31. The method of claim 30, further comprising the step of transmitting a consolation message to any individual who did not win the prize.

32. A method for enhancing user traffic to a particular website, comprising the steps of:
offering at least one prize for which multiple individuals can compete for in an on-line game;
issuing at least one prize ticket to any such individual who either visits a designated website of the prize offeror or refers at least one other individual to the website associated with the offeror; and
randomly awarding the prize to a particular individual associated with a winning prize ticket after a predetermined time period occurs.

33. The method of claim 32, further comprising the step of transmitting a consolation message to any individual who did not win the prize.

34. A software system for enabling sweepstakes functionality in a website, comprising:
a merchant interface that allows a merchant to add at least one prize associated with the merchant to a sweepstakes game that is electronically accessible by participants via a communications network, and allows a merchant to define rules governing both the issuance of prize tickets for such prize and the award of such prize to an appropriate participant of the sweepstakes game; and
a participant interface that allows one or more participants to earn at least one prize ticket for the prize, either by visiting the website of the merchant associated with the prize or referring at least one individual other than the participant to the website of the merchant associated with the prize.

35. The software system of claim 34, further including a database that is configured to maintain information sufficient to uniquely identify each such participant of the sweepstakes game and associate the prize tickets earned during the sweepstakes game with the appropriate participants such that a winning participant can be randomly chosen upon the occurrence of a predetermined event.

36. The software system of claim 34, wherein the predetermined event includes any of the issuance of a predefined threshold number of prize tickets or the satisfying of a predetermined time period.

37. The software system of claim 34, wherein the communications network is a computer network.

38. A system, comprising:
a server that is configured to provide access to one or more webpages via a communications network wherein at least one of the webpages is generated based on a set of programming instructions that define the characteristics and content of the webpage, and wherein the set of programming instructions include computer instructions that permit a sweepstakes game to be integrated with the content of the webpage, such that the server receives information associated with the sweepstakes game and displays at least a portion of such information on the webpage in which the sweepstakes game is integrated.

39. The system of claim 38, wherein the communications network is a computer network.

40. The system of claim 38, wherein the computer instructions constitute a Javascript program.

41. A system, comprising:
a software program executing on a first server over a communications network and configured to permit the submission of sweepstakes prizes to an on-line sweepstakes and define rules relating to the issuance of prize tickets for, and the awarding of, such sweepstakes prizes;
a second server that is configured to provide access to one or more webpages via a communications network wherein at least one of the webpages is generated based on a set of programming instructions that define the characteristics and content of the webpage, and wherein the set of programming instructions include computer instructions that permit the on-line sweepstakes to be integrated with the content of the webpage, such that the second server receives information associated with the on-line sweepstakes from the first server and displays at least a portion of such information on the webpage in which the on-line sweepstakes is integrated;
the second server permitting one or more participants to interact with the on-line sweepstakes via the communications network to earn at least one of the prize tickets for any of the sweepstakes prizes in the on-line sweepstakes, wherein the participant interaction is communicated to the first server;
a database in communication with the software program that is configured to maintain information sufficient to uniquely identify each such participant of the on-line sweepstakes and associate the prize tickets earned during the on-line sweepstakes with the appropriate participants such that each of the sweepstakes prizes in the on-line sweepstakes can be randomly awarded to particular ones of the participants in the on-line sweepstakes based on such participants being associated with a winning prize ticket for the respective sweepstakes prize upon the occurrence of a predetermined event.

42. The system of claim 41, wherein the communications network is a computer network.

43. The system of claim 41, wherein the computer instructions constitute a Javascript program.

44. The system of claim 41, wherein the predetermined event includes any of the issuance of a predefined threshold number of prize tickets for such sweepstakes prize or the satisfying of a predetermined time period.
